(19) United States
(12) Patent Application Publication
(10) Pub. No.: US 2025/0098663 A1
(43) Pub. Date: Mar. 27, 2025

(54) SHARK-PROOF WRIST BAND COMPRISING AN ELECTROMAGNETIC-BASED SHARK REPELLENT SYSTEM

(71) Applicant: Zakariah LaFreniere, Miami, FL (US)

(72) Inventor: Zakariah LaFreniere, Miami, FL (US)

(21) Appl. No.: 18/973,327

(22) Filed: Dec. 9, 2024

Related U.S. Application Data
(63) Continuation-in-part of application No. 17/714,991, filed on Apr. 6, 2022, now Pat. No. 12,172,738.
(60) Provisional application No. 63/172,273, filed on Apr. 8, 2021.

(51) Int. Cl. A01M 29/24; A01M 31/00; B63C 9/00; B63C 11/02; B63C 11/04; B63C 11/26; B64D 10/00

(52) U.S. Cl. CPC A01M 29/24; A01M 31/002; B63C 11/04; B63C 11/26; B64D 10/00; B63C 2009/0017; B63C 2009/0088; B63C 2011/021; B63C 2011/046

(57) ABSTRACT

A wrist-worn electromagnetic pulse generating wearable device for repelling great white sharks, tiger sharks, and bull sharks. i.e., the lethal shark breeds. The device includes an artificial intelligence/machine learning component (AI/ML) trained on a dataset including characteristics of the lethal shark breeds. A hydroactive sensor activates the device upon immersion in marine or fresh water. A signal generating component, responsive to AI/ML component, generates an ELF signal that radiates out to a 4 m area surrounding the user to repel shark attacks. Wave pulse characteristics, such as frequency, waveshape, and magnitude are determined by the AI/ML algorithm based on the detected shark breed. Antenna design based on fractal geometry (e.g., the T-square fractal, or the Sierpinski Triangle) generates an ideal isotropic radiation pattern. The wrist-mounted form factor of the inventive device offers improved performance over prior art devices.

### CROSS REFERENCE TO RELATED APPLICATIONS

The present application claims priority as a continuation-in-part application to the application assigned application Ser. No. 17/714,991 and filed on Apr. 6, 2022 (Attorney Docket 16544-001), and further claims priority, under 35 U.S.C. 119(e), to the provisional patent application filed on Apr. 7, 2021 and assigned application No. 63/172,273. These applications are incorporated herein in their entirety.

### FIELD OF THE INVENTION

The present invention relates to a wearable shark deterrent device that repels sharks at a distance by emitting non-lethal electromagnetic pulses in the low frequency spectral region (sometimes referred to as the ELF region). The preferred embodiment of the present invention is a wrist-mounted device that emits the electromagnetic pulses.

### BACKGROUND OF THE INVENTION

Since 1850, the U.S. has outpaced the world for ambush shark attacks according to the University of Florida International Shark Attack File. Presently, the list of fatalities is 1,596. The Sunshine State tops the nation with nearly 300 shark attacks-fatal and non-fatal, which outpaces the 181 attacks for the next four coastal States combined: North Carolina, South Carolina, California, and Hawaii.

We know from ichthyologists, such as Dr. Ryan Kempster, that of 500 shark species, three breeds distinguish themselves as lethal to humans: the great white shark, tiger shark, and bull shark. The latter breed being doubly lethal since bull sharks are able to inflict fatal attacks on humans in both marine and freshwater domains. In this application those three breeds are referred to as the “lethal three.” Hollywood has successfully commercialized the American phenomenon of galeophobia with scores of movies-most notably, Jaws, the 1975 classic directed by Steven Spielberg.

Prior art shows that in 2012, inventors Mr. Wilson Vinano and Mr. Clifford Lau tried to solve the great white shark attack problem with an ankle mounted electromagnetic pulse-based deterrent using a 4 cm dipole antenna. Originally dubbed “Electronic Shark Deterrent System” (ESDS), the renamed ESDS now sells for $790 online as No Shark.

The main engineering flaw of the No Shark device is that use of the dipole antenna generates an omnidirectional radiation pattern with nulls. These nulls represent literal chinks in the armor for a shark deterrent, leaving the user vulnerable to a small shark attack in the null zone. Also, the dipole antenna system is ill-equipped for compact antenna design since a wide separation is required between the electrodes to generate the desired ambit of protection.

The present invention seeks to protect the scuba diver or snorkeler with an average height of 183 cm.

The No Shark dipole antenna of just 10 cm provides repulsion protection at an impractical radius of about 15.2 cm. Thus, the No Shark device translates to “no shark” protection from an ambush shark attack due to flawed antenna design.

Another reason No Shark fails to offer adequate protection to protect American thalassophiles from shark attacks is that it was tested on three less than lethal shark breeds: Grey Reef Shark, Galapagos, and Oceanic White Tip. (see WO2012135394). When we look at the latest scientific data on those breeds we see the numbers pale in comparison to the “lethal three: ” Grey Reef Shark (9 attacks); Galapagos (2 attacks); Oceanic White Tip (15 attacks). This means that those three breeds combined for twenty-seven attacks, whereas data for the “lethal three” is as follows: great white shark (351 attacks), tiger shark (142 attacks), and bull shark attacks (119 attacks).

While it would be unreasonable for a single shark deterrent to repel all 500 known shark species, it would be reasonable for such a product to provide robust deterrence against the top three most lethal breeds. This is the gap that the Pulsarmis™ shark deterrent device (the commercial product that embodies the teachings of the present invention) seeks to fill. This coverage oversight means that the consumer who purchases No Shark and assumes they have comprehensive protection from all lethal sharks while in the Atlantic Ocean, is really being lured into playing Russian Roulette with their life.

Another flaw of the No Shark device is the use of a “high voltage” waveform. Scientific data by ichthyologists with subject matter expertise in shark electrosensory biology matters shows that it is a “low voltage” waveform (18 v) that best repels great white sharks. According to Dr Kempster's scientific study of the No Shark device:

“The results of this study showed that the ESDS [No Shark] did have an effect on C. carcharias [great white shark] behavior in very close proximity (≤15.5±1.2 cm), but the deterrent effect was not sufficient to completely prevent interactions with a static bait. Given the very short effective range of the ESDS . . . and the unreliable deterrent effect . . . it is doubtful that this device would dramatically reduce the risk of a negative shark encounter for the person wearing it. Ocean users should be very critical of shark deterrent claims, as the use of untested devices may actually put lives at risk by giving users a false sense of security. Future research should compare the behavioral responses of a range of shark species with other electric shark deterrents on the market, to determine species-specific differences in the effectiveness of these devices.”

The takeaway from Dr. Kempster is that at an effective No Shark device radius of 15 cm (5.9 inches) from the user provides meaningless shark protection, where it is unlikely that a 2,200 kg great white shark attacking from below at 56 km per hour would have sufficient time to be deterred at a 15 cm radius, and thereby abort the ambush attack.

Another commercial attempt at a wearable electromagnetic pulse based deterrent to protect spear fishers is the Shark Shield Freedom 7. See related US patent number U.S. Pat. No. 7,412,944. Unlike the $790 price tag for the No Shark device, SSF7 retails for $500 online by Ocean Guardian. Australian ichthyologists, like Dr. Charlie Huveneers, have tested SSF7 on great white sharks, which was designed to discourage ambush rearward attacks on spear fishers. (Huveneers C, Rogers P J, Semmens J M, Beckmann C, Kock A A, Page B, et al. (2013) Effects of an Electric Field on White Sharks: In Situ Testing of an Electric Deterrent. PLoS ONE 8 (5): e62730.) Dr. Huveneers and his research team found that the SSF7 device was able to deter great whites “˜56% of the time, at 2 m.” If so then, why has there been no abatement in American shark attack rates in light of the SSF7? The inventor has studied the $500 SSF7 device and determined that it is mainly the poor form factor and antenna design.

The SSF7 device attempts to lengthen the radius between dipoles by affixing the power unit to the ankle, and the second dipole antenna attached to a seven-foot steel antenna. See Figures in prior art patent U.S. Pat. No. 7,412,944.

Here, the flawed design poses a safety hazard where the spear fisher attempts to swim through coral, high sea grass, or cave diving. The remote ankle mounted location creates the added burden of having to look down and away from the direction of travel in order to regularly monitor the SSF7 lithium ion battery level. This is further complicated by the kicking leg, and murky waters. The Pulsarmis™ device solves this problem with the more convenient wrist mounted location, and improved compact antenna design.

Another obvious problem is that the Ocean Guardian SSF7 solution applies only to a niche market (spear fishers), and ignores other impacted groups who are also at high risk for ambush shark attacks while in the Atlantic Ocean, like surfers and scuba divers. So the Ocean Guardian solution is to create two new product designs aimed at the surfer and the scuba diver as separate entities: Freedom+Surf to protect surfers and SCUBA7 for scuba divers.

The $540 Freedom+Surf is essentially a “pulsing surfboard” that integrates the dipole antenna design into the underside of a surfboard by way of a flexible antenna. This creates an economic burden where it is unlikely that a surfer who has spent $2,000 for a premium surfboard, would want to downgrade to a $540 surfboard just to gain access to the pulsing technology. Worse, for those who make the investment, the $540 Freedom+Surf device provides protection only in a few narrow scenarios: (1) when the surfer sits idle with both legs dangling; and (2) when the surfer paddles out to an approaching wave. What about the case where the surfer falls from the board and must swim 10 m back to the board? Obviously, there is zero shark protection when separated from the Freedom+Surf device.

The SCUBA7 is the $740 device that affixes the pulse technology to the air tank and the diver's ankle in an attempt to provide ambush shark attack protection for scuba divers. While a laudable attempt, this is a narrow use case that has no universal appeal for a wide array of swimmers. The Pulsarmis™ device is therefore an improvement on the concept, as further described below, since it can repeal any type of shark without forcing the consumer to purchase a surfboard, or an ankle mounted pulse system with a 2 m trailing steel cord to radiate the ELF wave pulses.

Another oversight of the Ocean Guardian and No Shark ankle mounted pulse devices is the failure to address functionality in both marine and freshwater domains. The Pulsarmis™ device resolves this disadvantage.

Another flaw in the No Shark device that was reported by Dr. Kempster and his research team is the tendency of great whites to develop a “pulse tolerance” over time. Both SSF7 and No Shark devices emit a static low hertz pulse; therefore, it was reported by Dr. Kempster in his research that some great white sharks tended to show tolerance to the dose as evidenced by ever increasing approaches to the armed bait over time. To quote Dr. Kempster:

“As suggested by Kempster et al. [How Close is too Close? The Effect of a Non-Lethal Electric Shark Deterrent on White Shark Behaviour”] it is likely that the time between pulses of an electric deterrent will play an important role in the effectiveness of the device. The ESDS [No Shark], for example, pulsed at a rate of 7.8 Hz for 2.5 s, but was then inactive for a period of 2.6 s between pulse bursts, whereas, the Shark Shield [SSF7] pulsed continuously at a rate of 1.67 Hz. Therefore, the ESDS was actually inactive for 2.6 s between every 2.5 s burst of pulses (i.e. the device was inactive 51% of the time), whereas the Shark Shield was only inactive for approximately 0.6 s between pulses. When we consider that the time taken between encounters can be as short as 18 s . . . it is very likely that individuals may have encountered an active ESDS during the 2.6 s inactive period between pulses. This likely explains why so many sharks interacted during active ESDS trials . . . as many of those interactions may have occurred during the 2.6 s inactive period. Therefore, the ESDS may be improved by reducing the inter-pulse interval, but this is unlikely to have any significant impact on the effective deterrent range of the device, as this is a factor of the strength of the voltage gradient and electrode spacing, rather than pulse frequency. Due to the compact size of the ESDS, the electrodes are spaced very close to one another (10 cm apart), which will limit its potential deterrent range because of the exponential decay in field strength with distance beyond the dipoles.”

Another obvious disadvantage in the SSF7 and No Shark devices, is the antiquated power source: a lithium ion battery. There have been a number of reports showing the public safety threat posed by consumer products that are powered by thermal runaway (fire hazard) and weak energy density power sources, such as lithium ion batteries. The weak energy density issue is ubiquitous for items such as mobile phones and tends towards a phenomenon known as “battery anxiety.” With respect to a wearable shark deterrent, lithium ion batteries in the SSF7 and No Shark devices create a gap where there are no viable alternatives for “energy dense” products like Pulsarmis™ device.

A few notable fatalities with the SSF7 are illustrative:
Peter Clarkson fatality. In 2011, witnesses reported that the late Mr. Clarkson always wore a SSF7 which was later confirmed by the presence of small floats from the tail of the device on the surface following the fatal attack. In the coroner's findings, the main reference to Shark Shield Technology was:

“Mr. Clarkson always wore a Shark Shield which he attached to his belt. It is a [lithium ion] battery operated device which can be switched on and off and is designed to repel any sharks as they approach. Mr. Rodd said that sometimes Mr. Clarkson would turn the Shark Shield off when he was on the bottom but most of the time he would switch it on when he entered the water and then switch it off again when he got to the surface. Mr. Rodd did not know whether Mr Clarkson had the Shark Shield turned on at the time of the incident that occurred on 17 Feb. 2011.”
Garry Johnson fatality. In 2020, the late Mr. Johnson wore a SSF7 at the time of the shark attack. It is likely that the SSF7 was temporarily “powered off” to mitigate the risk of shock while securing a line to a rock on the seafloor. Unfortunately, in this brief moment, Mr. Johnson suffered a fatal attack by a great white shark.

American history shows that it is not just the civilian segment of society that needs the benefit of a new robust great white shark deterrent. Since the close of World War II, the Department of Defense (DoD) in general, and the U.S. Navy in particular, have been interested in integrating a reliable shark deterrent for warfighters (e.g. Navy aviators, Navy SEALs, etc.), according to ichthyologist Dr. Carl Meyer at the Hawaii Institute of Marine Biology.

Perhaps the greatest illustration of the need for robust shark protection occurred toward the close of World War II with the U.S.S. Indianapolis disaster where the heavy cruiser was struck by a pair of torpedoes fired from an Imperial Japanese Navy I-58 submarine in the south Pacific Ocean. Out of the 1,196 Naval aviators and sailors on board, about 300 died on impact. Survivors found alive by aerial search and rescue, such as the late U.S. Marine Sgt. Edgar Harrell, cited the fact that while the DoD issued kapok jackets provided adequate protection against death from drowning, they offered zero protection against ambush shark attack while stranded in the open ocean. To date, the U.S.S. Indianapolis represents the single greatest loss of life from sharks in U.S. maritime history.

The instant innovation, the Pulsarmis™ device, would therefore have utility both in the civilian sector, as well as the U.S. DoD, and federal government: spear fishers, snorkelers, scuba divers, life-guards, triathletes, underwater photographers, marine biologists, submarine archeology, Navy warfighters, Navy Seals, U.S. Coast Guardsman, U.S. Air Force pilots, FBI USERT, DEA dive teams, etc.

In short, while it is laudable that a number of inventors have made noble attempts to save lives through innovation in wearable shark protection, the present devices available such as the $500 SSF7, and the $790 No Shark, fail to adequately solve the problem. We have duly cited several material engineering flaws in both SSF7 and No Shark that make both inventions ripe for innovation herein via the Pulsarmis™ invention.

### BRIEF SUMMARY OF THE INVENTION

A first aspect of one embodiment of the present invention is an improved wearable electromagnetic pulse based great white shark deterrent method and device employing low frequency or extremely low frequency (ELF) wave pulses in the 1 Hz to 100 Hz spectrum, and low voltage magnitude with an isotropic radiation pattern offering the Pulsarmis™ user ambush shark attack protection out to about 4 m.

The inventive device, in the ideal preferred embodiment, is affixed to the wrist, opposite the arm that would normally carry a dive computer, in the case of a scuba diver. Rather than emit a simple static pulse, upon shark attack, the Pulsarmis™ device incorporates an AI/ML algorithm that determines the dynamic characteristics of the generated pulse depending on the breed of shark detected.

The AI/ML model is trained on the “lethal three” shark metrics, which includes the great white shark, the tiger shark, and the bull shark. The training focuses on unique features of each breed including shape of snout, profile, skin markings, etc.

Another advantageous aspect of the invention comprises a hydro-active feature. Once the device is submerged in either marine water or freshwater the device activates. This is useful in the event that the user is multi-tasking and enters the water forgetting to power on the device. While powered on, the device will not emit any pulses until triggered by the detection of a great white, tiger shark, or bull shark.

To alleviate user concerns about lithium ion “battery anxiety,” the device uses an energy-dense battery such as a graphene-based battery.

A further aspect of the present invention that improves utility for the user is an improved compact antenna design over a dipole antenna. The problem with the dipole antenna configuration is that it generates an omnidirectional radiation pattern with nulls. The nulls are literal chinks in the armor that may be exploited by some shark breeds such as bull shark. It is possible for a user of the SSF7 to suffer a fatal attack when a shark attacks through this unprotected zone (nulls) in the omnidirectional radiation pattern. The present invention solves this problem by using a monopole micro strip patch antenna array with fractal geometry that generates the ideal isotropic radiation pattern within a smaller area.

The Sierpinski gasket, comprising a plurality of fractal antennas, for example, generates an ideal isotropic radiation pattern with zero nulls. The radiated field can be “amplified” by arranging the antennas in an array, taking advantage of the physics principle of “constructive interference” in the radiation pattern.

### BRIEF DESCRIPTION OF DRAWINGS

FIG. 1 shows a block diagram of a shark repellent system according to one embodiment of the present invention.

FIG. 2 shows one embodiment of a shark proof apparel flight suit embodying the shark repellent system of FIG. 1.

FIG. 3 shows one embodiment of a shark proof apparel wet suit embodying the shark repellent system of FIG. 1.

FIG. 4 shows a life vest embodying the shark repellent system of FIG. 1.

FIG. 5 shows an exemplary fractal antenna for use with the shark repellent system of the present invention.

FIGS. 6A, 6B, and 6C show several waveforms that the shark repellent system of the present invention can generate and transmit to repel sharks.

FIG. 7 shows an omnidirectional radiation pattern for a fractal geometry antenna such as the fractal antenna for use with the present invention.

FIG. 8 shows the top view of the Pulsarmis™ device for attachment to a user's wrist in a preferred embodiment.

FIGS. 9 and 10 each shows a different fractal antenna for use with the device of the present invention.

FIG. 11 shows a flow chart describing the intended logic flow of the operation of the device, including the AI/ML feature of the present invention.

FIG. 12 shows a learning mode of a device incorporating an AI/ML model or algorithm for use in detecting the three lethal shark breeds.

FIG. 13 shows an exemplary computer system for use with the present invention.

### DETAILED DESCRIPTION OF THE PREFERRED EMBODIMENTS

The present invention, referred to commercially as a Pulsarmis™ device, is a wrist-mounted (in one embodiment) electromagnetic pulse generator-based shark deterrent. Placing the device on the wrist provides maximum visibility and ease of use.

The Pulsarmis™ device functions in both marine and freshwater domains filling this protection gap in commercially available wearable electromagnetic pulse devices.

Recognizing the shortcomings of commercially available shark deterrents, such as the Shark Shield Freedom 7 and No Shark, the Pulsarmis™ device fills the present product gaps and solves this public safety dilemma for the United States which leads world in shark fatalities. The present invention, in the preferred wrist mounted embodiment, has wider utility to a broader array of thalassophiles than the garment-based shark deterrent found in the prior art, such as the Australian inventor Lyon (WO 2018/107202A1). This would represent the Pulsarmis™ device advancing the flawed prior art of SSF7 or No Shark and reasonably includes snorkelers, scuba divers, lifeguards, appeals to a wider array of consumers than either SSF7 or No Shark, including: spear fishers, snorkelers, scuba divers, life-guards, triathletes, underwater photographers, marine biologists, submarine archeologists, U.S. Navy Aviators Navy Seals, U.S. Coast Guardsmen, U.S. Air Force pilots, FBI, USERT, DEA dive teams, etc.

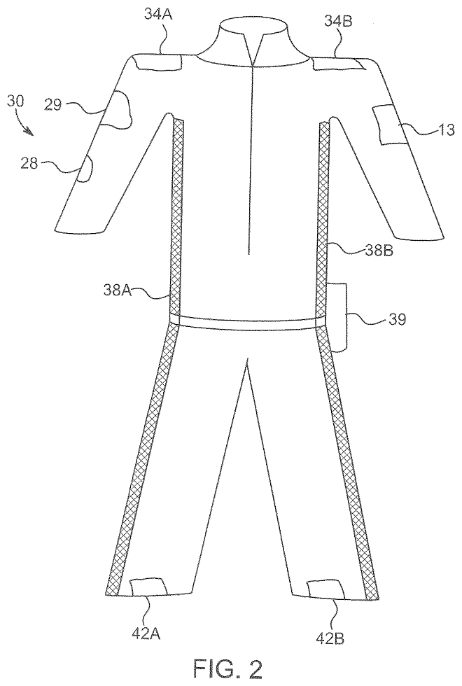

A shark proof apparel including a shark repellent system is provided to prevent or reduce the number of shark attacks upon military and civilian personnel operating in environments where sharks may be present. The system of the invention comprises a garment or apparel item configured to be worn by an individual, where the word apparel is broadly construed to include any wearable outside of a garment such as the instant wrist mounted invention. The bi-lateral electromagnetic shark repellent system for generating an electromagnetic field is embedded within the garment. See FIGS. 2-4 as exemplars.

In one embodiment the electromagnetic fields radiate in all directions from the garment wearer (omnidirectionally) and are controlled by pulse signals. Specifically, the fields radiate from shoulder-mounted antennas (dipole or monopole) and from bilateral fractal pattern antennas. The fields are also radiated from the antennas (monopole or dipole) near the ankle of the wearer. In one embodiment the fields exhibit a pulse-like form as they radiate from the various antennae of the present invention.

Each low frequency pulse, with a pulse frequency of about 40 Hertz, generates an isotropic omnidirectional electromagnetic field to repel an approaching great white shark at about a four meters radius from the wearer.

In another embodiment, the ELF train of pulses are triggered by the presence of any one of the lethal three shark breeds according to an algorithm to generate the isotropic radiation pattern out to about 2 m from the user.

Also, in the garment or wetsuit embodiment the invention comprises two redundant shark repellent systems that can be activated concurrently or independently, which run laterally down the side of the wetsuit, flight suit, etc. Each one of the two systems can be controlled by the user to transmit the repelling electromagnetic radiation from one or more of the laterally extending T fractal antennae associated with each pulse system.

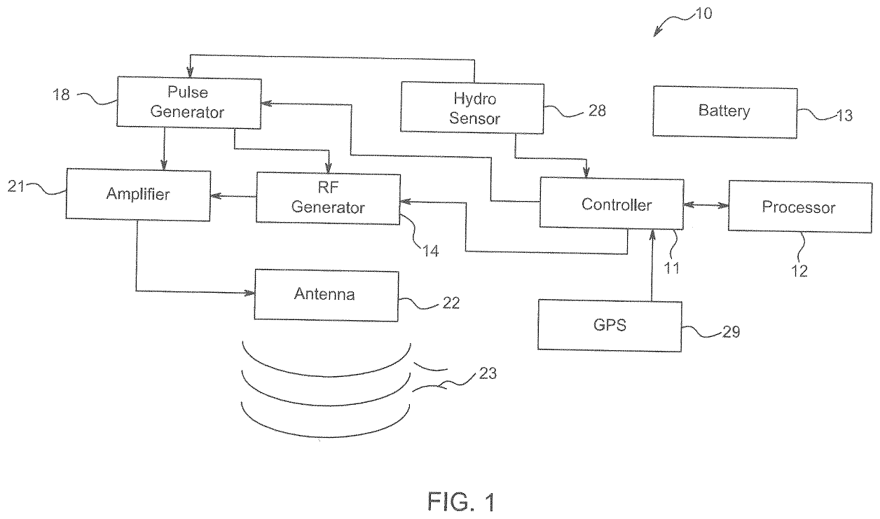

FIG. 1 illustrates a block diagram of a shark repellent system 10. The system comprises a system controller 11 and a signal generator 14 for generating signals under control of a pulse generator 18. When a pulse is input to the generator 14, the generator produces a signal for input to an amplifier 21 and then to an antenna 22. During intervals between pulses no signal is generated and thus no signal is transmitted from the antenna 22. The antenna 22 emits electromagnetic waves, depicted by field lines 23.

The system further includes an artificial intelligence/machine learning algorithm, as described further herein, that is executed by a processor 12. The Pulsarmis™ algorithm modulates each ELF pulse train of wave pulses based upon the trained dataset of any one of the three lethal shark breeds, that is, great white shark, tiger shark, and bull shark.

The controller 11 is activated responsive to a signal from one or more water sensors (e.g., hydro sensors) 28. Typically, the sensors are mounted on or integrated with the flight suit, wet suit, or vest. The hydro sensors detect the presence of marine of fresh water upon entry by the wearer of the device.

Responsive to the water sensors 28, the controller activates the pulse generator 18 and/or the RF generator 14 for generating the signals radiated from the fractal geometry antenna 22. In another embodiment further described below, the pulses are generated and shaped accordingly, responsive to an AI/ML algorithm as further described below.

The controller may operate manually in order to manage the device ON or OFF modes.

In the OFF mode no electromagnetic signals are transmitted from the antenna 22. This mode may be used, for example, to avoid detection when a Navy Seals team is performing a covert operation and seeks to operate silently without generating any electromagnetic noise to enemy forces.

In one operational mode the user controls the system to activate (or terminate) emissions of the electromagnetic pulses. Specifically, in this mode the user/wearer can control the system to issue a single pulse or many pulses as desired. However, this mode is not the preferred operational mode.

The ON mode is the system default when the hydro sensors detect the presence of either marine or fresh water. While in the ON mode, the device will remain in standby mode to conserve power and emit ELF pulses only when triggered by the presence of a great white shark, tiger shark, or bull shark and continue for the eight hour charge of the graphene battery power source.

The Pulsarmis™ device includes a global positioning system or GPS 29 as a safety feature to ensure prompt rescue by the U.S. Coast Guard when stranded at sea.

A battery 13 supplies power to the various elements of the system. In the preferred wrist mounted embodiment, Pulsarmis™ device moves away from the current flawed lithium ion battery, which may be prone to “thermal runaway” increasing product liability and also has poor energy density leading to “battery anxiety,” in favor of the more energy dense graphene battery. With the amalgamation of an energy dense battery source, like graphene, the inventor imagines that the device would last up to eight hours on a single charge and recharge up to sixty times faster than lithium ion batteries.

Although only one antenna is illustrated in FIG. 1 block diagram, according to the garment-based embodiment, such as a neoprene wetsuit or flight suit, the bilateral electromagnetic pulse system, which runs laterally from shoulder to ankle (or runs laterally shoulder to ankle on both sides of the wearer) includes two fractal geometry antennas, such as the T-square fractal antenna integrated directly into the neoprene substrate layer.

The garment-based embodiment of the invention, such as a neoprene wetsuit or a flight suit, comprises a single system as illustrated in FIG. 1 for supplying signals to all antennae. A preferred embodiment comprises a second redundant system identical to the system of FIG. 1. One system supplies the signal for transmission to the antennae on the wearer' right side (34A, 38A, and 42A), and a second system supplies the signal for transmission to the antennae on the wearer's left side (34B, 38B, and 42B). The two systems can be controlled for concurrent or independent operation.

With two redundant systems, the other elements in FIG. 1 are also duplicated in both systems, e.g., two GPS units, two hydro sensors. two batteries (e.g., two graphene batteries). One battery supplies power to the first pulse system and the elements thereof and the second battery supplies power to the elements of the second pulse system.

Referring now to FIG. 2, there is shown a shark repellent flight suit 30 with the shark repellent system of FIG. 1 integrated with the suit or disposed on or within the suit.

The suit 30 comprises two bilateral shoulder-mounted antennae 34A and 34B. In one embodiment there is an electrode at the shoulder and the ankle and a flexible T-square fractal geometry antenna integrated into the fabric of the garment. The secondary or redundant antennae system is in lieu of the single antenna 22 illustrated in the system block diagram of FIG. 1.

The suit 30 further comprises two bilateral fractal pattern antennae 38A and 38B (also known as fractal antennae) for more effective generation of electromagnetic fields in a smaller surface area; again, the fractal pattern antennae are in lieu of or in addition to the antenna 22 illustrated in FIG. 1.

As is known by those skilled in the art, a fractal antenna is an antenna that uses fractal, self-similar geometrical designs, such as the “Minkowski fractal” or the “Sierpinski triangle” to maximize its radiation efficacy within modern compact antenna design and applications. Generally, a fractal antenna comprises a motif that repeats over two or more scale sizes or iterations. Such antennas are generally considered wideband in that the fractal antenna can create radiating fields over a wide frequency range.

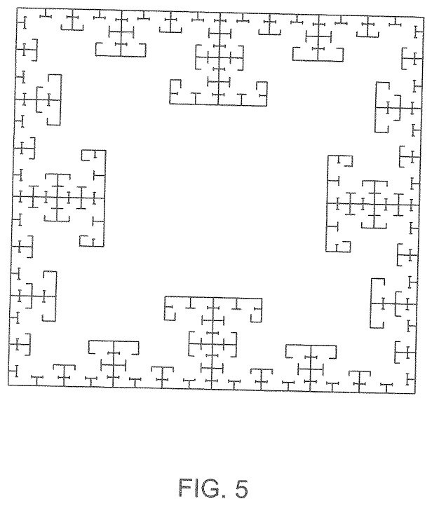

As depicted, in one embodiment the fractal antennae 38A and 38B each comprise a T-square fractal as illustrated in FIG. 5. In any case, each fractal antenna extends about five feet or 60″ bilaterally from a shoulder region to an ankle region of the garment.

The controller 11 (and the processor 12 and the battery 13) can be separately mounted, as for example within an enclosure 39 illustrated in FIG. 2. In another embodiment, the battery can be mounted proximate one of the shoulder-mounted antennae 34A and 34B. Or in yet another embodiment may be mounted at a different location on an interior-facing surface of the garment or between the interior and exterior facing surfaces of the garment.

Additionally, yet another dipole or monopole antenna 42A and 42B can be disposed at the far end of each the fractal antennae 38A and 38B, i.e., proximate the wearer's ankle.

Different embodiments may comprise any number of the various antennae illustrated in FIG. 2. Preferred antenna types have been described herein, such as the Sierpinski triangle, however, a person of ordinary skill in the art is best positioned to select the ideal fractal geometry pattern (and antenna type) as best suited for the purpose of reliably repelling lethal shark breeds like the great white shark, the tiger shark and the bull shark.

The elements of the shark repellent system are powered by the rechargeable graphene battery power source 13 disposed on or within the garment at any convenient location, such that all devices in the system of FIG. 1 can be easily connected to the power source. Alternatively, the battery is enclosed within the water proof enclosure 39. The battery can be recharged by conventional techniques known to those skilled in the field, such as a wireless induction pad.

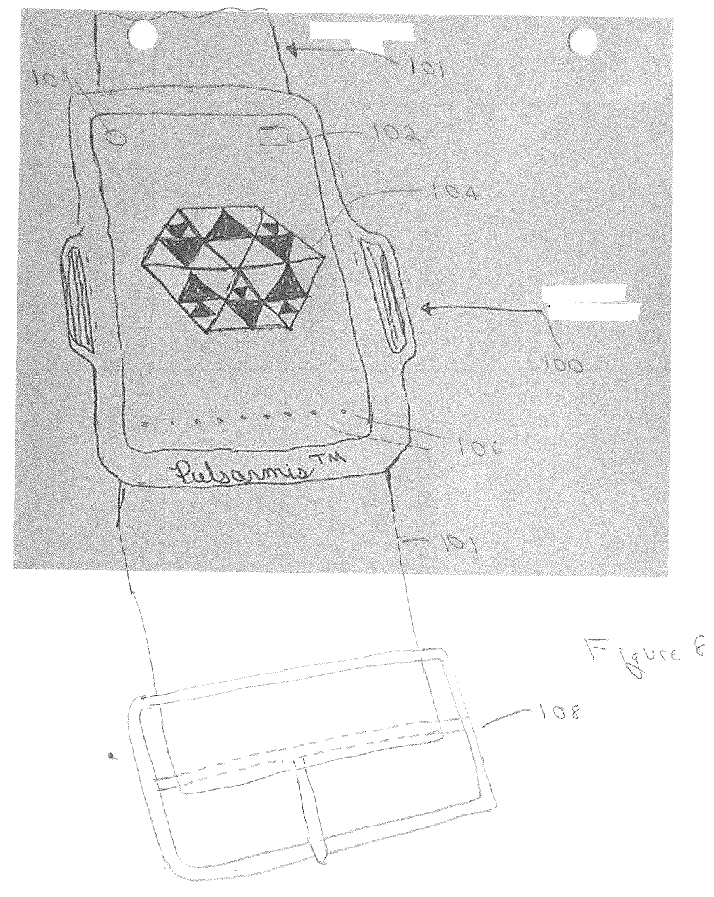

In the preferred wrist-mounted embodiment the graphene battery power source is integrated directly into the wrist worn device as depicted in the top view of FIG. 8.

FIG. 2 also depicts the hydro or water sensor 28 that activates the system when the sensor is submerged in water, either marine water or fresh water.

Alternatively, the hydro sensor can be disposed within the enclosure 39 with an active surface of the sensor exposed to detect the presence of water surrounding the suit 30. More than one hydro sensor may be present in certain embodiments of the invention.

FIG. 2 also depicts the GPS 29 disposed on the suit 30. Other locations on the suit are suitable for the GPS. Preferably, the GPS is housed inside a water tight encasement within the garment or on an exterior surface of the garment.

As described above, one embodiment of the present invention includes two ELF pulse systems that run laterally in the garment embodiment such as wetsuit and flight suit and life vest with one such system presented in FIG. 1. Clearly, in the garment embodiment, with the redundant pulse systems, the various elements of the second redundant system must be appropriately located on the suit 30. Further, in the event that one of the two pulsing systems fails (e.g., the battery associated with that system is completely discharged), the backup or redundant pulse system may be activated by the user to activate the algorithm generated shark repelling electromagnetic signals.

In yet another embodiment, the various system antennae associated with the first system can receive a signal for transmission from the second system. This provides additional redundancy than a two-system embodiment wherein each system can supply signals to only the antenna associated with that system. Thus, in the event one antenna is not functional for any reason, another antenna can serve as a backup. Also, both systems can be concurrently activated by the user, but this may not be necessary given the duplicate radiation patterns of the antennas and the unnecessary battery discharge with two operable systems.

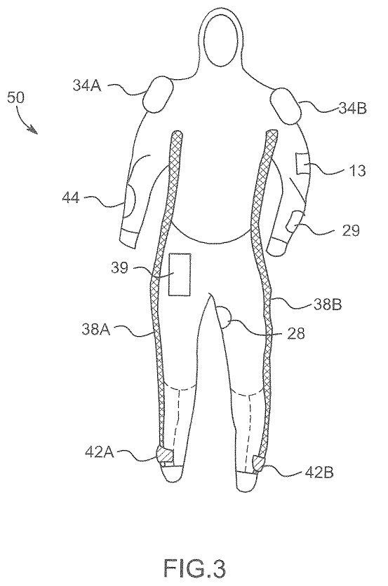

Referring now to FIG. 3, there is shown one embodiment taking the form of a wetsuit 50 that includes the shark repellent system of the present invention. The elements identified in FIG. 3 with like reference numerals from other figures, have the same function and operation as described in conjunction with other figures of the present application. Also, the dual ELF pulse system embodiment may be utilized with the wet suit 50 embodiment.

The “wetsuit/dry suit embodiment” is designed for use by a diver in a cold-water environment, such as Alaska. Structurally, the dry suit is configured to fully cover the diver and to prevent water from penetrating into the interior region of the dry suit by use of a layer of air.

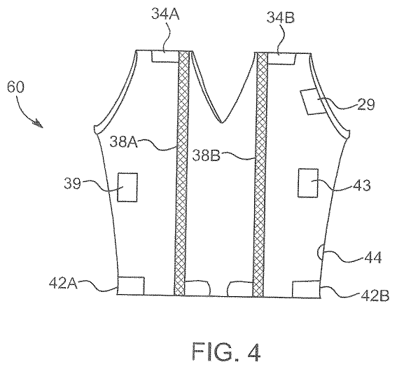

Referring now to FIG. 4, there is shown a shark proof life vest 60 that includes the shark repellent system of the present invention, where T-square fractal geometry antenna radiating the ELF pulses is integrated directly into the fabric of the life vest. The shark proof life vest comprises an inflation mechanism (not shown) such as those embedded into a traditional life vest. As such, the shark proof life vest provides buoyancy to suspend the wearer while in a body of water and intended to provide ambush shark attack protection while awaiting rescue by the U.S. Coast Guard if stranded deep in the ocean.

The reference numerals in FIG. 4 refer to the same elements with the same functionality as in FIGS. 1, 2, and 3. Although certain locations for these elements have been depicted, those skilled in the art are aware that the elements can be relocated to other locations on the life vest 60 and further disposed on an interior or exterior facing surface (as appropriate) or within the vest.

In one embodiment, a singular integrated shark repellant system and its constituent components is placed on or within the shark proof life vest. However, in alternative embodiments, a plurality of such shark repellent systems may be utilized. In the illustrated embodiment, the system elements are in operable connection with one or hydro sensors 44, such that the system is activated in the presence of marine water or fresh water sources such as a lake.

Also, the dual system or ELF Pulse system redundancy described herein can be utilized with the life vest embodiment 60.

Referring now to FIG. 5, there is shown a T-square fractal antenna depicted as an exemplar of fractal geometry that may be integrated into the garment and suitable for use with the shark repellent system as the antenna 22 in FIG. 1 or the fractal antennae 38A and 38B as depicted in the various embodiments of the ELF pulse system. The T-square fractal antenna can also be integrated with the wrist-mounted embodiment further described herein.

Although the present system has been described as emitting a Train of low hertz wave pulses from about 20 Hz to 60 Hz, according to another embodiment a detection system determines one or more of the size, speed, and breed of the shark and based thereon an artificial intelligence/machine learning algorithm (executed by the processor 12) determines an appropriate frequency (possibly outside the 20-60 Hz range) and other signal parameters for emission by the shark repellent system. If the signal is transmitted in a pulse-like form, the time between pulses (i.e., the pulse waveform period or the duty cycle) is variable and again as determined by the Pulsarmis™ AI/ML algorithm. Additionally, the algorithm continues to adjust the signal parameters as determined by a distance between the wearer and the shark.

Additionally, the algorithm stores data of each shark encounter by any user of the system of the invention. Thus, the shark repellent system records every encounter with a shark, including various encounter-related metrics, such as shark size, approach speed and approach angle. The data accumulates over time as more system users experience more shark encounters. The primary data recording algorithm uses an artificial intelligence/machine learning (AI/ML) algorithm to control the electromagnetic radiation to more effectively repel sharks, and may be able to perform software updates over time in order to provide a more robust shark, deterring system.

Thus, rather than limited to one static EFL, signal frequency or duration, which may become moot when the shark acquires a tolerance, the preferred pulse system employs the AI/ML algorithm Specifically, trained on the lethal three data set (great white shark, tiger shark, and bull shark) to initiate a breed specific pulse parameter in order to increase the statistical probability of a successful attack repulsion at 2 m radius.

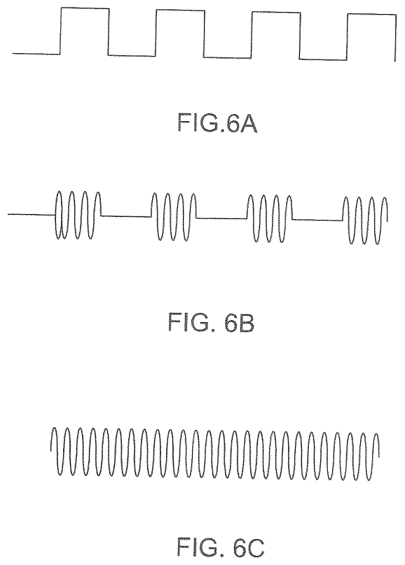

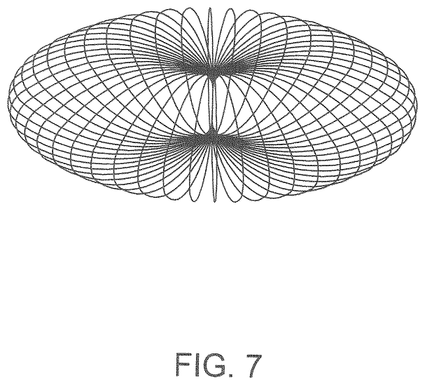

The signal emitted from the antennae of the system may take any one of several formats, as each may be effective in repelling sharks in specific circumstances. Such signal formats are depicted in FIGS. 6A, 6B, and 6C.

FIG. 6A illustrates a pulse waveform with a 50% duty cycle and a representative frequency in a 20 to 60 Hz range. The frequency and pulse duty cycle are variable under control of the processor or controller, which in turn, in one embodiment, is controlled by the AI/ML algorithm. The duty cycle can vary between about 10% and 90% and the frequency can vary between about 10 Hz and about 100 Hz.

FIG. 6B illustrates radio frequency (RF) pulses where the pulse-like envelope of the RF signal has characteristics as described in FIG. 6A. The radio frequency signal has a frequency between about 20 Hz and about 100 Hz.

FIG. 6C illustrates a continuous sinusoidal signal have a frequency between about 20 Hz and about 100 MHz.

The use of other waveforms and other frequencies, such as triangle and sawtooth waveforms are also contemplated by the present invention.

It is known by ichthyologists, such as Dr. Ryan Kempster and Dr. Charlie Huveneers, that ELF wave pulses of low voltage are effective at repelling great white sharks at about 2 m radius.

The various described garments embodying the inventive shark repellent system may be made of any suitable material, including currently used materials such as cotton, hemp, leather, steel and aluminum. Additionally, the present invention may be implemented on any number of garments of different structures and materials. Specific garment measurements vary to fit the body shape and size of the wearer.

One embodiment of the present invention pertains to an improved wearable electromagnetic pulse-based shark deterrent comprising AI/ML generated pulses in the low frequency spectrum (˜20 Hz to 100 Hz), and emitting low voltage waves (˜18 V) out to a Fraunhofer region of about 2 m from the user. This preferred embodiment of this wearable device, worn on the wrist, independent of a neoprene wet suit substrate layer, cotton flight suit, or life vest as depicted by FIG. 8.

The AI/ML algorithm is specifically trained on a dataset of the “lethal three” shark metrics, which includes elasmobranchs that typically result in a fatal attack, that is, great white sharks, tiger sharks, and bull sharks. The training and execution phases are described below.

A first aspect of the present invention comprises a wrist strap constructed of sustainable textile material, such as hemp or some other suitable material, that is neither toxic to the user nor harmful for the environment.

In the preferred embodiment, a strap affixes the device to the user's wrist with adjustments by way of a buckle or a hook and loop material, to adjust the strap for different size wrists and user comfort.

See FIG. 8, which depicts the device 100 attached to a wrist strap 101. Visible on an outer surface of the device are a manual ON/OFF switch 102, a fractal geometry antenna, such as the Sierpinski triangle arranged in a hexagonal array 104, water sensors 106, and a buckle 108 for securing the wrist strap 101 to a user's wrist. Another embodiment employs a hook and loop fastening mechanism in lieu of the buckle. Various other components of the device, as further described below, are disposed within the device Such as a graphing battery for power and algorithms for managing the ELF pulses 100.

In the preferred embodiment of the wrist mounted device, the exterior of the device comprises a hydrophobic enclosure comprising sustainable textile material being neither toxic to the user nor to the environment. The hard exterior enclosure is hydrophobic or sealed to prevent marine water or fresh water from penetrating the device and corroding the internal circuits and components, which would result in device failure and zero shark protection for the user.

A further aspect of the device hardware comprises a backlit screen display to convey vital statistics and information to the user, such as the battery charge level, pulse activation, which of the lethal three shark breeds was repelled, radius of repulsion, number of shark repulsions, etc.

A further aspect of the device hardware comprises a master power ON and OFF switch (element 102 in FIG. 8) allowing the user to manually activate or deactivate the device.

A further aspect of the present invention comprises a hydro-active sensing system (element 106 in FIG. 8) to automatically power “on” the device upon immersion in saline or freshwater. The utility of this feature is safety or engineering redundancy in the event that the spear fisher, scuba diver, or snorkeler forgets to power on the device upon entering shark infested waters. A reverse process occurs upon the user exiting from water, that is the device powers off to conserve the rechargeable battery power.

A further aspect of the present invention, disposed within the device, comprises a motion detection and image acquisition system, wherein the device will scan out to a 4 m radius from the user for evidence of objects that display features associated with the three lethal shark breeds, i.e., great white shark, tiger shark, and bull shark. The critical metrics include snout, skin markings, and the like.

Upon detection of one of the three breeds by execution of the trained AI/ML algorithm, a train of low frequency electromagnetic pulses is generated by the device and transmitted from the fractal geometry antenna 104. Details of the pulse train (e.g., frequency, waveform, voltage) are also dependent on the shark breed detected.

A further aspect of the present invention entails an AI/ML model or algorithm trained on identifying characteristics of the great white shark, tiger shark and bull shark. These elasmobranch metrics initially train the model and detection accuracy improves over time as the model is continually retrained. Dataset metrics may include shark bite radius, snout geometry, skin color markings, pectoral fin configuration, and the like.

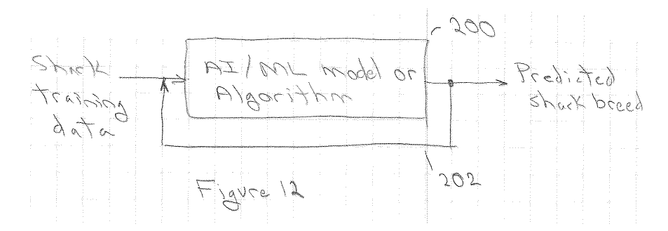

FIG. 12 represents the training phase of the AI/ML model or algorithm 200.

Presently, the prior art for wearable electromagnetic pulsed base shark deterrence shows that there is no commercially available electromagnetic pulse-based wearable shark deterrent that has been specifically trained on the “lethal three” shark metrics, which is to say great white shark, tiger shark, and bull shark. This is how the Pulsarmis™ device fills the market gap and moves the field forward in terms of innovation and greater utility for the widest array of consumers.

Generally, the AI/ML training phase (See FIG. 12) involves feeding a machine learning model or algorithm with large amounts of labeled data (e.g., this data element is the snout of a great white shark), allowing the algorithm to identify patterns and relationships within the data, and gradually adjusting its internal parameters (weights) to improve its ability to make accurate predictions on new, unseen data. This process essentially “teaches” the model to perform a specific task by iteratively refining its responses based on feedback from the training data.
A. Key preliminary steps in the AI/ML training phase include the following:
   Collection of data relevant to the desired task, ensuring it includes both input features and corresponding target values (labels). Here the desired task involves accurate detection of lethal three shark breeds.
   Model Selection, that is, choosing an appropriate machine learning model or algorithm (such as linear regression, decision trees, neural networks) based on the problem to be solved and characteristics of the data.
   Setting initial weights for the model parameters.
B. The training steps involve the following:
   Forward Propagation: Feeding input data through the model to generate predictions.
   Loss Calculation: Comparing the model's predictions with the actual target values to calculate an error (loss function).
   Backpropagation: Using the calculated loss to adjust the model's weights in the opposite direction to minimize the error, thereby iteratively refining the model's parameters. See the feedback path 202 in FIG. 12.
C. The evaluation phase involves the following:
   Testing the trained model on a separate validation dataset to assess its performance metrics (accuracy, precision, recall) and identify potential overfitting issues.

Once the model or algorithm has been trained, it is used to evaluate data acquired during the scanning process of collecting object images and other data in the proximate environment of the device user.

The AI/ML algorithm, upon determining that one of the three shark breeds is proximate the user, triggers generation of radio wave pulses in the low frequency spectral region, that is, between about 20 Hz and about 80 Hz. The device, specifically, the antenna(s), radiate in an ideal isotropic radiation pattern with no nulls out to about 4 m radius from the user. The wave amplitude, in one embodiment, is about 9.7 V/m to about 15.7 V/m. Scientific research has shown this magnitude to be effective at repelling great white sharks at about 2 m from the user. The shape, frequency, magnitude, etc. of the pulse train are selected based on the shark breed detected. Thus the waveform is

The device will receive periodic software updates, including up-to-date dataset metrics, such that all users of the device may benefit from other successful shark repulsions.

A further aspect of the present invention comprises an improved compact antenna design that departs from the flawed 2 m steel cord antenna to radiate the ELF wave pulses and towards a fractal geometry antenna design as taught by Dr Balwinder S. Dhaliwal, from the 2023 publication, “Fractal Antenna Design Using Bio Inspired Computing Algorithm” which shows that the fractal based compact antenna design outperforms. the antiquated “two electrodes” or dipole antenna paradigm employed by commercially available products using 6 m steel cords, like the Shark Shield Freedom 7 or shorter dipole antenna designs like the No Shark device.

Additionally, a preferred embodiment of the invention employs a fractal geometry antenna such as the Sierpinski triangle fractal design antenna with an improved isotropic radiation pattern.

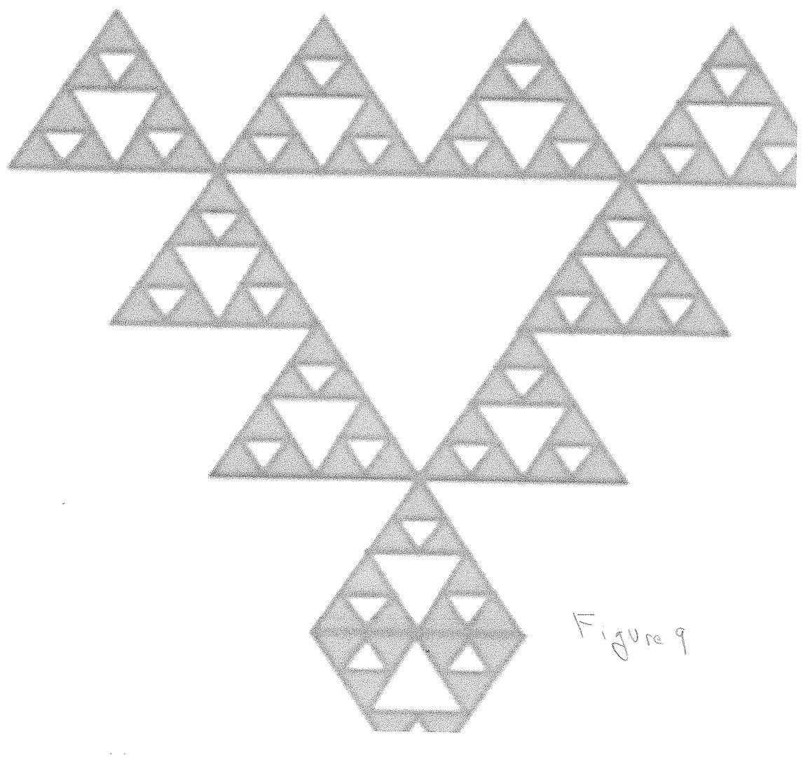

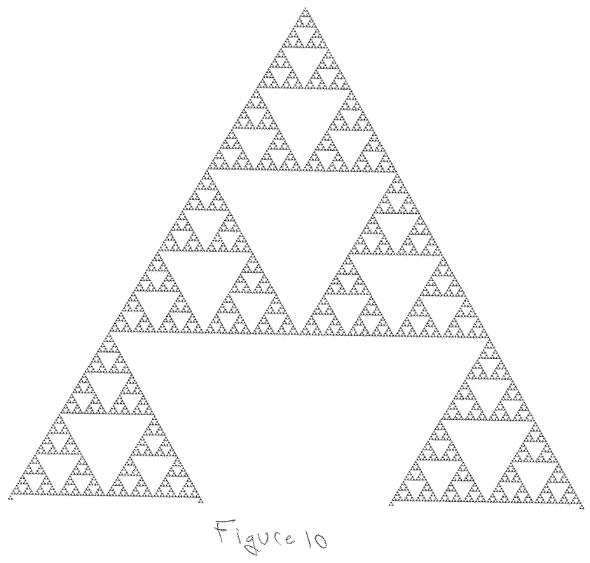

The preferred inventive antenna is based on a compact antenna design that employs fractal geometry. One embodiment uses the Sierpinski fractal antenna (see FIG. 9), which is also referred to as the Sierpinski gasket. This antenna has an isotropic radiation pattern, that is, the antenna radiates (and receives) equally in all directions, horizontally and vertically, with the same intensity. The radiation pattern resembles a sphere with the antenna placed at the center. See also FIG. 10 for another fractal antenna, also referred to as the Sierpinski triangle or Sierpinski gasket.

The major problem with the dipole antenna system of the prior art, such as the $500 Shark Shield Freedom 7 ankle mounted shark deterrent is the less-than-ideal omnidirectional pattern that includes pattern nulls. Nulls are tantamount to having chinks in armor when in battle and in the case of the Shark Shield Freedom 7 the poor placement of the device at the ankle means that much of the protective radiation is wasted in the 6 m wake, leaving the vital organs of the torso open to an ambush attack from directly below while swimming horizontally in the ocean. A bull shark or tiger shark could exploit this flaw and attack a spear fisher in a null region, thereby posing a product liability issue for commercially available wearable shark deterrents like the $500SSF 7 and $700 No Shark.

To overcome the fatal flaw, the present invention, the Pulsarmis™ device embraces fractal geometry such as the Sierpinski gasket for improved compact antenna design. In one embodiment the Sierpinski gasket comprises an array of eight to ten antennas and thereby augments wave gain by taking advantage of the physics principle of “constructive interference.”

The inventor of the current device, Mr. LaFreniere, believes that in theory the wrist mounted embodiment of the Pulsarmis™ device can exceed the current great white shark repulsion statistics reported by Dr. Kempster for the SSF7 or “56% at 2 m radius.” The present invention improves the great white shark repulsion rate by at least 80% at 2 m radius due to the improved compact antenna design using fractal geometry, such as the Sierpinski triangle. FIG. 9 illustrates the Sierpinski Triangle that generates an isotropic radiation pattern. FIG. 10 illustrates a slightly different version of the Sierpinski triangle.

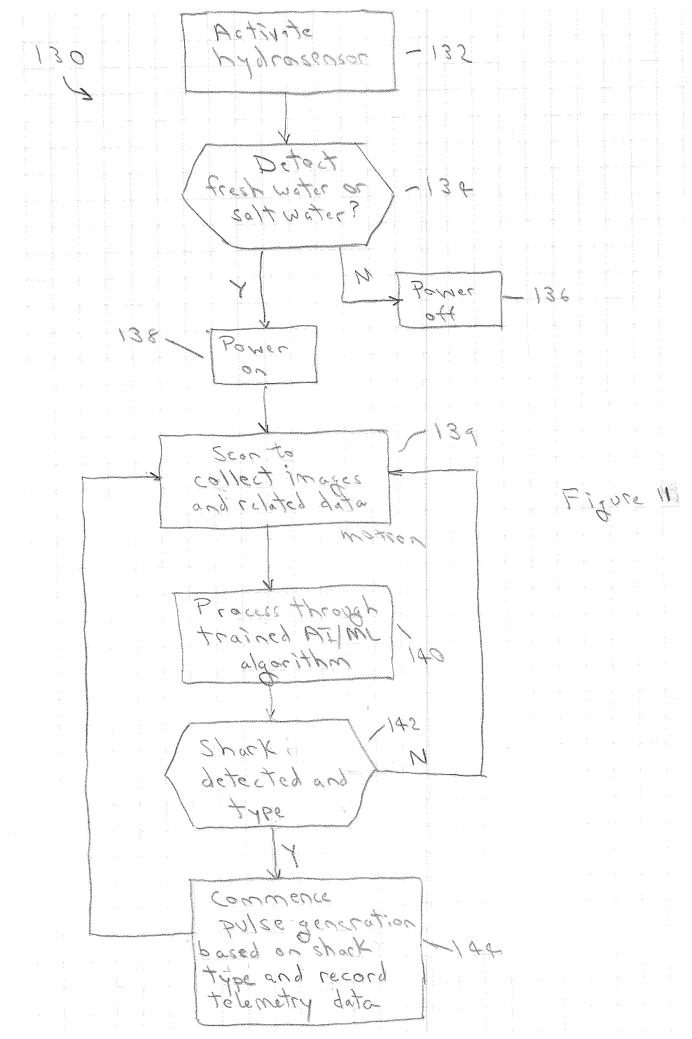

FIG. 11 depicts a flow chart 130 describing operation of the present invention. At a step 132 a hydro sensor (element 106 of FIG. 8) is activated when the user enters the water. At a step 134 the water is determined as either fresh water or salt water. If neither, processing moves to step 136 where power to the device is turned off.

If the response from step 134 is affirmative, processing moves to step 138 where power is supplied to the device.

At a step 139 the area surrounding the device (that is, the user wearing the device) is scanned out to a 4 m radius for evidence of the lethal three shark breeds. That is, the great white shark, the tiger shark, and the bull shark.

Processing then moves to step 140 where the trained AI/ML algorithm processes the information collected at step 139 to determine whether a shark is present in the area surrounding the user and the shark breed.

A Boolean decision step 142 responds with a “no” response if a shark was not detected, and a “yes” response if a shark was detected based on the data collected at the step 139 and the results of the process of step 140. The affirmative response also includes the shark type.

That affirmative response triggers the electromagnetic pulses to be generated at a step 144. The pulses (frequency, magnitude, etc.) are defined according to the shark breed detected. Step 144 also indicates that certain telemetry data related to the shark encounter is recorded, including angle and radius of attack, number of attacks, date of attack, details of the electromagnetic pulses emitted.

After processing through step 144, processing returns to the surveillance mode of step 139.

The device provides periodic indications (by way of a flashing LED 109 in FIG. 8, for example) of battery charge status.

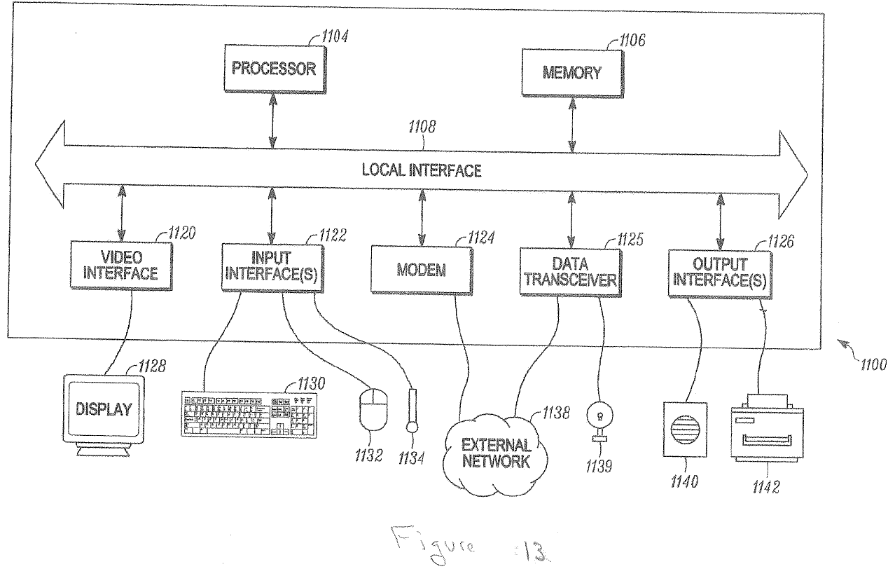

FIG. 13 illustrates a computer system 1100 for use in practicing the invention, including training the AI algorithm (FIG. 12) and using the trained Al algorithm to detect the shark and identify the shark breed.

The system 1100 can include multiple remotely-located computers and/or processors and/or servers (not shown). The computer system 1100 comprises one or more processors 1104 for executing instructions in the form of computer code to carry out a specified logic routine that implements the teachings of the present invention.

The computer system 1100 further comprises a memory 1106 for storing data, software, logic routine instructions, computer programs, files, operating system instructions, and the like, as is well known in the art. The memory 1106 can comprise several devices, for example, volatile and non-volatile memory components further comprising a random-access memory RAM, a read only memory ROM, hard disks, floppy disks, compact disks including, but not limited to, CD-ROM, DVD-ROM, and CD-RW, tapes, flash drives, cloud storage, and/or other memory components. The system 1100 further comprises associated drives and players for these memory types.

In a multiple computer embodiment, the processor 1104 comprises multiple processors on one or more computer systems linked locally or remotely. According to one embodiment, various AI/ML related tasks associated with the present invention may be segregated so that different tasks can be executed by different computers/processors/servers located locally or remotely relative to each other.

The processor 1104 and the memory 1106 are coupled to a local interface 1108. The local interface 1108 comprises, for example, a data bus with an accompanying control bus, or a network between a processor and/or processors and/or memory or memories. In various embodiments, the computer system 1100 further comprises a video interface 1120, one or more input interfaces 1122, a modem 1124 and/or a data transceiver interface device 1125. The computer system 1100 further comprises an output interface 1126. The system 1100 further comprises a display 1128. The graphical user interface referred to above may be presented on the display 1128. The system 1100 may further comprise several input devices (some which are not shown) including, but not limited to, a keyboard 1130, a mouse 1131, a microphone 1132, a digital camera, smart phone, a wearable device, and a scanner (the latter two not shown). The data transceiver 1125 interfaces with a hard disk drive 1139 where software programs, including software instructions for implementing the present invention are stored.

The modem 1124 and/or data receiver 1125 can be coupled to an external network 1138 enabling the computer system 1100 to send and receive data signals, voice signals, video signals and the like via the external network 1138 as is well known in the art. The system 1100 also comprises output devices coupled to the output interface 1126, such as an audio speaker 1140, a printer 1142, and the like.

This Description of the Invention is not to be taken or considered in a limiting sense, and the appended claims, as well as the full range of equivalent embodiments to which such claims are entitled define the scope of various embodiments. This disclosure is intended to cover any and all adaptations, variations, or various embodiments. Combinations of presented embodiments, and other embodiments not specifically described herein by the descriptions, examples, or appended claims, may be apparent to those of skill in the art upon reviewing the above description and are considered part of the current invention.

Sundry modifications to the preferred wrist mounted embodiment may become apparent to a person of skill in the art, being in harmony with the principles disclosed herein. All such embodiments and modifications are construed to fall within the claims as set forth below.

The foregoing descriptions of specific embodiments of the present invention have been presented for purposes of illustration and description. They are not intended to be exhaustive or to limit the present invention to the precise forms disclosed, and obviously many modifications and variations are possible in light of the above teachings.

The exemplary embodiments are chosen and described in order to best explain the principles of the present invention and its practical application, to thereby enable others skilled in the art to best utilize the present invention and various embodiments with various modifications as are suited to the particular use contemplated.

What is claimed is:

1. A wearable device for wearing by a user and for generating an electromagnetic signal to repel underwater aquatic animals, the device comprising:
a strap or band for removably attaching the wearable device to the user;
a sensing component for scanning an area surrounding the user, and for collecting information during scanning;
a detection component for receiving and analyzing the information collected during scanning, for detecting an underwater aquatic animal based on results of an analysis, and for generating a control signal responsive to the results;
a signal generating component for receiving the control signal and for generating an electromagnetic signal responsive thereto, wherein characteristics of the electromagnetic signal are determined according to a species or breed of a detected underwater aquatic animal;
a fractal geometry antenna responsive to the electromagnetic signal for transmitting the electromagnetic signal to create a field in an area proximate the user, the field for repelling the underwater aquatic animal; and
a water sensor for enabling the device to transmit the electromagnetic signal when the water sensor senses presence of water.

2. The wearable device of claim 1, wherein the strap further comprises a wristband.

3. The wearable device of claim 1, wherein a frequency of the electromagnetic signal is between about 1 Hz and 100 Hz.

4. The wearable device of claim 1, wherein the fractal geometry antenna geometry comprises a T-square fractal antenna or a Sierpinski triangle antenna.

5. The wearable device of claim 1, wherein a radiation pattern of the fractal geometry antenna comprises an isotropic radiation pattern.

6. The wearable device of claim 1, further comprising a GPS device for determining a location of the user.

7. The wearable device of claim 1, further comprising a rechargeable graphene battery.

8. The wearable device of claim 1, wherein characteristics of the electromagnetic signal comprise, a square wave with a frequency in a range of about 20 Hz to 80 Hz, or a sinusoidal signal with a frequency in a range of about 20 Hz to 100 Hz with a pulse-like envelope, a sinusoidal signal with a frequency in a range of about 20 Hz to 100 Hz, or a sawtooth waveform.

9. The wearable device of claim 1, wherein components of the wearable device operate in an ON mode and an OFF mode, controllable according to a configuration of a manually-operated switch.

10. The wearable device of claim 9, wherein in the ON mode the electromagnetic signal is transmitted continuously from the fractal geometry antenna.

11. The wearable device of claim 1, wherein the signal generating component is operable in a manual mode, wherein in the manual mode the user manually controls the signal generating component to activate and terminate generating of the electromagnetic signal.

12. The wearable device of claim 1, the detection component for determining that the underwater aquatic animal comprises a bull shark, a tiger shark, or a great white shark based on a dataset comprising one or more of a size, speed, and anatomical features of the bull shark, the tiger shark, and the great white shark, and for generating the control signal identifying a shark breed, and wherein responsive to the control signal and an identified shark breed, the signal generating component for generating a signal having characteristics for repelling the identified shark breed.

13. The wearable device of claim 12, wherein the dataset is updated over time.

14. The wearable device of claim 12, wherein characteristics of the signal are determined by a distance between the wearer and the underwater aquatic animal.

15. The wearable device of claim 1, wherein the detection component comprises an artificial intelligence/machine learning algorithm trained on datasets representing a great white shark, a tiger shark, and a bull shark.

16. The wearable device of claim 1, the sensor comprising a motion detector and an image acquisition component for scanning to about a 4 m radius from the user.

17. The wearable device of claim 1, wherein the electromagnetic signal can repel the underwater aquatic animal at a distance of about 4 m.

18. The wearable device of claim 1, wherein the fractal geometry antenna comprises a micro strip patch antenna with a fractal geometry.

19. A first wearable device of claim 1 for attaching the first wearable device to a first region of the user's body and a second wearable device of claim 1 for attaching the second wearable device to a second region of the user's body, the first region different from the second region.

20. The wearable device of claim 1, wherein the strap comprises a closure mechanism for securing the wearable device to the user.
